(19) United States
(12) Patent Application Publication
(10) Pub. No.: US 2019/0354325 A1
(43) Pub. Date: Nov. 21, 2019

(54) DEVICE MANAGEMENT SERVER, DEVICE MANAGEMENT METHOD, AND DEVICE MANAGEMENT SYSTEM

(71) Applicant: SEIKO EPSON CORPORATION, Tokyo (JP)

(72) Inventors: Eriko SONEHARA, Shiojiri (JP); Norihiko YAMADA, Nagano (JP); Koki TOGASHI, Shiojiri (JP); Satoshi JOBETTO, Shiojiri (JP)

(21) Appl. No.: 16/412,551

(22) Filed: May 15, 2019

(30) Foreign Application Priority Data
May 17, 2018 (JP) 2018-095151

(51) Int. Cl. G06F 3/12; G06Q 10/08; G06K 15/00

(52) U.S. Cl. CPC G06F 3/1229; G06Q 10/083; G06F 3/129; G06F 3/1203; G06K 15/407

(57) ABSTRACT

A device management server that manages a plurality of devices includes a receiving unit that receives consumables information on a status of consumables in the devices, a first determination unit that determines whether or not a first device needing replacement of the consumables is included in the devices, a second determination unit that, when the first device is included in the devices, determines whether or not a second device needing replacement of the consumables is included in the devices other than the first device, and a delivery instruction unit that, when the second device is included in the devices, provides an instruction to deliver a replenishment item of the consumables needed by the first device for replacement and a replenishment item of the consumables needed by the second device for replacement.

The present application is based on, and claims priority from JP Application Serial Number 2018-095151, filed May 17, 2018, the disclosure of which is hereby incorporated by reference herein in its entirety.

### BACKGROUND

### 1. Technical Field

The disclosure relates to a server, a method, and a system that manage devices.

### 2. Related Art

The related art discloses a printer consumables management system that includes an information receiving unit that receives consumables information on the status of consumables provided in a printer device, a comparison unit that determines consumables as a first replacement target in accordance with comparison of the consumables information with a first threshold and, when consumables as the first replacement target have been determined in accordance with the comparison with the first threshold, determines consumables as a second replacement target in accordance with comparison of consumables information on consumables other than the first replacement target with a second threshold, and a delivery instruction unit that provides an instruction to deliver replenishment items of the consumables of the first replacement target and the consumables of the second replacement target (see, for example, JP-A-2016-45550). According to such a system, delivery of replenishment items for a plurality of consumables provided in the same printer device is instructed, and thereby delivery costs for consumables may be reduced.

In a situation where a plurality of devices such as printers are operated in different places, however, another problem of inefficiency arises because consumables are individually delivered to the plurality of devices.

### SUMMARY

According to an aspect of the disclosure, a device management server that manages a plurality of devices includes a receiving unit that receives consumables information on a status of consumables provided in the devices, a first determination unit that determines whether or not a first device that needs replacement of the consumables is included in the devices in accordance with a comparison of the consumables information with a first threshold, a second determination unit that, when the first device is included in the devices, determines whether or not a second device that needs replacement of the consumables is included in the devices other than the first device in accordance with a comparison of the consumables information with a second threshold, and a delivery instruction unit that, when the second device is included in the devices, provides an instruction to deliver a replenishment item for the consumables needed by the first device for replacement and a replenishment item for the consumables needed by the second device for replacement.

### BRIEF DESCRIPTION OF THE DRAWINGS

FIG. 1 is a diagram schematically illustrating a configuration of a system.

FIG. 2 is a flowchart illustrating a process according to the embodiment.

FIG. 3 is a flowchart illustrating the detail of step S33.

FIG. 4 is a diagram illustrating an example of a part of group management information.

FIG. 5 is a diagram illustrating an example of a replacement list.

FIG. 6 is a diagram illustrating an example of a part of group management information including location information.

FIG. 7 is a flowchart illustrating the detail of step S33 different from FIG. 3.

### DESCRIPTION OF EXEMPLARY EMBODIMENTS

Embodiments of the disclosure will be described below in accordance with the attached drawings. Note that each drawing is a mere example for illustrating the present embodiment.

### 1. General Description of System

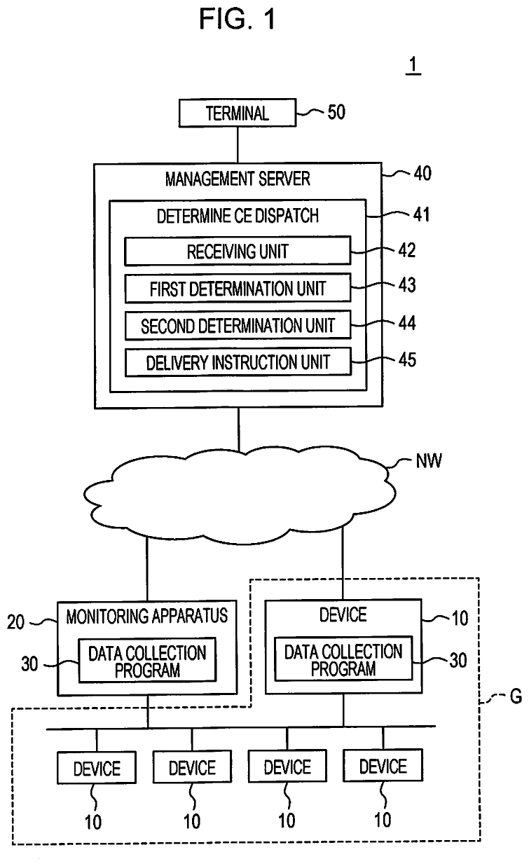

FIG. 1 schematically illustrates the configuration of a system 1 employed in the present embodiment. The system 1 includes a plurality of devices 10, a monitoring apparatus 20, and a management server 40. The management server 40 corresponds to a device management server that manages a plurality of devices. Further, the management server 40 is an operating entity of a device management method. The devices 10 are devices to be managed by the management server 40. Each of the devices 10 is a printer. However, the device 10 may correspond to various devices such as a scanner, a multifunction device, a projector, or the like.

Management of the devices 10 performed by the management server 40 in the present embodiment generally refers to collecting from the devices 10 consumables information on a status of consumables provided in the devices 10, determining in accordance with the collected consumables information whether or not replacement of consumables is needed, and providing an instruction to deliver a replenishment item for consumables in accordance with the determination.

The plurality of devices 10 and the monitoring apparatus 20 are connected to a wired or wireless Local Area Network (LAN) constructed on a site and are able to communicate with each other in accordance with a predetermined communication protocol. The data collecting program 30 is installed in the monitoring apparatus 20, which is a computer. The plurality of devices 10 illustrated in FIG. 1 may be referred to as a device group G. The device group G is a group associated with a contract, for example. The term “contract” herein refers to a contract to be managed by the management server 40. Although FIG. 1 illustrates a single device group G, there are other device groups G to be managed by the management server 40.

The monitoring apparatus 20 and the management server 40 are connected to a network NW including a public communication line such as the Internet. A protocol such as Simple Mail Transfer Protocol (SMTP), Hypertext Transfer Protocol (HTTP), Extensible Message and Presence Protocol (XMPP), or the like may be used in the communication between the monitoring apparatus 20 and the management server 40.

The management server 40 is formed of a single computer or multiple computers in which a device management program 41 is installed. When the management server 40 is formed of a plurality of computers, respective computers of the management server 40 may be connected by a LAN or connected via the Internet. When a processor runs the device management program 41, the management server 40 is a device management apparatus that functionally has a receiving unit 42, a first determination unit 43, a second determination unit 44, and a delivery instruction unit 45. Note that the management server 40 in the case of being formed of a plurality of computers may be a device management system. Further, a terminal 50 is connected to the management server 40. The terminal 50 is a computer that is operated or viewed by a user (manager) who engages in management or operation of the management server 40 or management or operation of services provided by the management server 40.

### 2. Consumables Management for Device Group

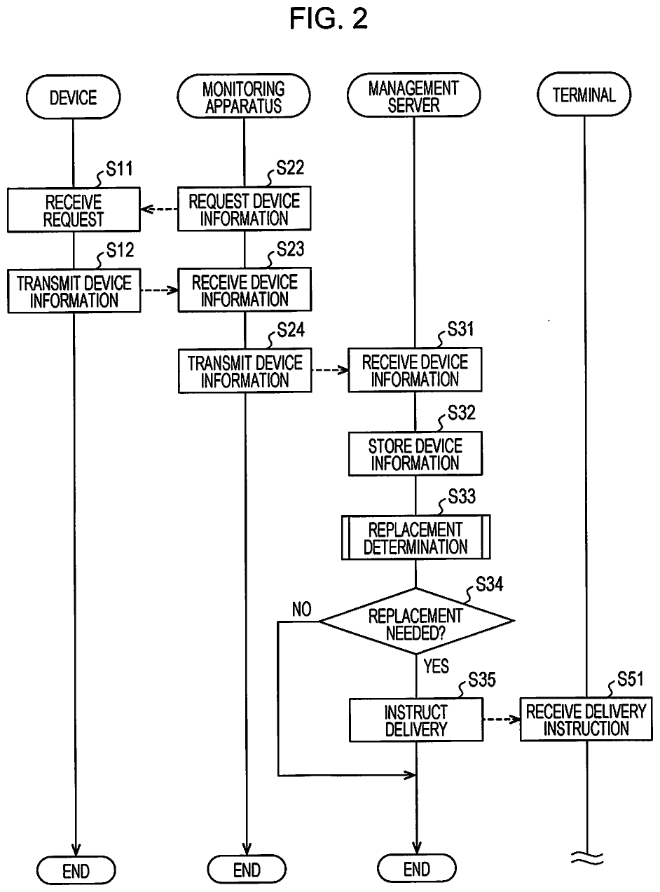

The flow of the process performed in the system 1 will be described with reference to FIG. 2. FIG. 2 illustrates a flowchart of respective processes of the device 10, the monitoring apparatus 20, the management server 40, and the terminal 50. The monitoring apparatus 20 that runs the data collecting program 30 determines whether or not the time of report provided to the management server 40 has come and, in response to determining that the reporting time has come, starts the process illustrated in FIG. 2. The reporting time may be determined in advance to occur at constant time intervals, such as, one day, one week, one month, or the like. For example, the monitoring apparatus 20 determines that the reporting time has come when 24 hours has passed from the last transmission of device information to the management server 40.

The monitoring apparatus 20 requests device information from each of the devices 10 in the device group G (step S22). The process of the device 10 illustrated in FIG. 2 is performed by each of the devices 10 that have received a request for device information from the monitoring apparatus 20. In response to receiving the request (step S11), the device 10 transmits the device information thereon to the monitoring apparatus 20 (step S12).

The device information of the device 10 includes a serial number of the individual device 10, error information, consumables information, or the like. The error information is information indicating that an error has occurred in the device 10 or indicating details of the error.

For example, when the device 10 is a printer, the consumables information includes the accumulated number of sheets for color printing, the accumulated number of sheets for monochrome printing, ink levels of ink containers or ink cartridges for respective colors, the remaining life of a feed roller, the remaining capacity of a waste tank, or the like. The device 10 updates and stores consumables information in a non-volatile memory in accordance with the output of a sensor or a counter and transmits the consumables information to the monitoring apparatus 20 in response to a request from the monitoring apparatus 20. Ink levels, the remaining life of a feed roller, the remaining capacity of a waste ink tank, or the like may each be referred to as a remaining consumables level. The remaining consumables level is expressed by percentage, where an unused state corresponds to 1006.

In response to receiving device information from the device 10 (step S23), the monitoring apparatus 20 transmits the received device information to the management server 40 via the network NW (step S24). The monitoring apparatus 20 transmits, to the management server 40, the device information received from each device 10 in the device group G that has requested the device information in step S22 collectively in step S24. Note that the monitoring apparatus 20 may transmit the received device information to the management server 40 on every occasion of receiving the device information from each device 10.

As illustrated in FIG. 1, the data collecting program 30 may be installed on the device 10. The device 10 on which the data collecting program 30 is installed also functions as the monitoring apparatus 20. That is, the device 10 on which the data collecting program 30 is installed determines arrival of the reporting time as described above and, in response to determining that the reporting time has arrived, transmits its own device information to the management server 40 via the network NW (step S24). Further, if it is determined that the reporting time has arrived, the device 10 in which the data collecting program 30 is installed receives device information from each device 10 in the device group G (that is, performs steps S22 and S23) and transmits the received device information to the management server 40 via the network NW (step S24).

In response to receiving device information (step S31), the management server 40 stores the received device information (step S32). As described above, device information includes consumables information. Therefore, step S31 corresponds to a receiving step of receiving consumables information on a status of consumables provided in the device 10. Further, the management server 40 that performs step S31 functions as the receiving unit 42. Next, the management server 40 determines whether or not replacement of consumables is needed in accordance with comparison of the stored device information with a predetermined threshold (step S33).

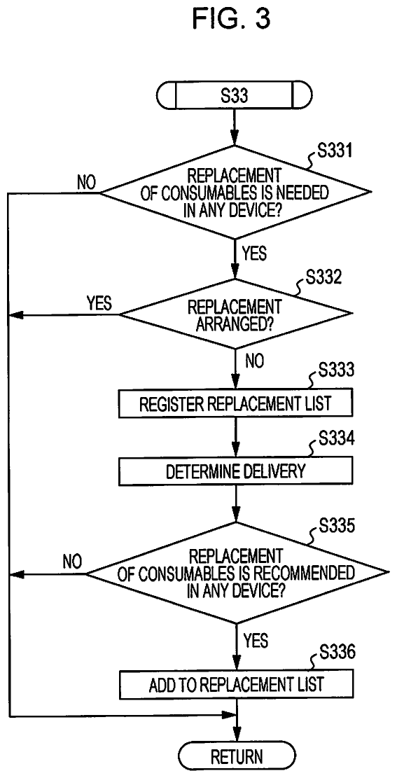

FIG. 3 illustrates the details of step S33 by using a flowchart. In step S331, the management server 40 determines whether or not the device 10 (first device) which needs replacement of consumables is included in the plurality of devices 10 that are the sources of the device information in accordance with comparison of consumables information with a predetermined first threshold. Step S331 corresponds to the first determination step. Further, the management server 40 that performs step S331 functions as the first determination unit 43.

The process of step S33 (FIG. 3) is performed targeting a single device group G. That is, in step S331, the management server 40 compares the consumables information of each device 10 with the first threshold by referencing device information of each device 10 belonging to a certain device group G stored in step S32. The first threshold is preset for each type of consumables information (remaining consumables level), for example, an ink level, the remaining life of a feed roller, and the remaining capacity of a waste ink tank. For example, when the ink level of the device 10 (device a) belonging to a certain device group G is below the first threshold to be compared with the ink level, the management server 40 determines that the device a is one of the first devices.

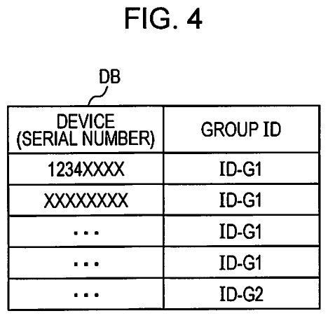

The management server 40 pre-stores group management information that defines a correspondence between the devices 10 and the device group G to which the devices 10 belong. FIG. 4 illustrates an example of a part of a group management information DB. In the example of FIG. 4, the group management information DB defines the correspondence between serial numbers of the devices 10 and group IDs. The group ID is identification information uniquely defined for one of the device groups G and, for example, set in accordance with a contract. By referencing the serial number included in the stored device information and the group management information DB, the management server 40 can determine that the devices 10 having the same group ID are the devices 10 in the same device group G. As an example, the management server 40 targets a certain device group G whose group ID is “ID-G1” and determines whether or not the first device is included therein.

As a result of referencing the stored device information, if no device 10 whose remaining consumables level is below the first threshold is included in the targeted device group G, the management server 40 determines that no device 10 (first device) needs replacement of consumables (step S331, NO), and step S33 ends. On the other hand, if one or more devices 10 whose remaining consumables level is below the first threshold are included in the targeted device group G, the management server 40 determines that the first device is included (step S331, YES), and the process proceeds to step S332.

In step S332, the management server 40 determines whether or not replacement of consumables has been arranged for the first device determined to be included in step S331, and the process ends step S33 if arranged (step S332, YES) and proceeds to step S333 if not arranged (step S332, NO).

For example, in step S331, the management server 40 determines that the first device is included because the black (K) ink level of the device a included in the device group G whose group ID is “ID-G1” is less than the first threshold. In such a case, the black ink (an ink container of black ink) is the consumable that is to be replaced in the device a. Consumables to be replaced may be referred to as replaceable consumables. A serial number for each consumable (consumables serial number) is provided to each replaceable consumable in the device 10 during manufacturing. Further, consumables information included in device information transmitted from the device 10 includes the consumables serial number for each consumable. When having arranged certain replaceable consumables, the management server 40 records the consumables serial number of the specific replaceable consumables (consumables before being replaced) as a serial number of a replaceable consumable for which replacement has been arranged. Thus, when the consumable serial number of an ink container of black ink as consumables information in device information of the device a matches any serial number of a replaceable consumable for which replacement has been arranged, the management server 40 can determine that replacement has been arranged for the ink container of black ink for the device a as the first device.

If replacement has been arranged for all the replaceable consumables of the first device determined to be included in step S331 (consumables whose remaining consumables level is below the first threshold), the management server 40 determines “YES” in step S332. On the other hand, if replacement has not yet been arranged for at least some of the replaceable consumables of the first device determined to be included in step S331, the management server 40 determines “NO” in step S332. Determination in step S332 may avoid repeated arrangement of replacement for one consumable (delivery of a replenishment item).

In step S333, the management server 40 registers replacement consumables for the first device in a replacement list LD. That is, the management server 40 registers, in the replacement list LD, consumables which have not yet been arranged for replacement out of the replaceable consumables of the first device determined to be included in step S331. In response to registering replaceable consumables in the replacement list LD, the management server 40 then determines delivery of a replenishment item for a replaceable consumable (step S334), and the process proceeds to step S335.

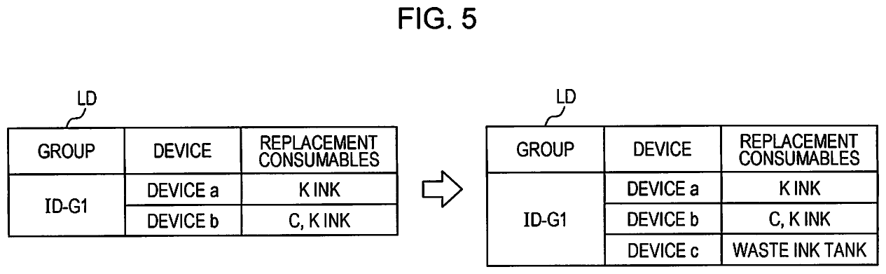

FIG. 5 illustrates an example of the replacement list LD. The replacement list LD on the left side in FIG. 5 is the replacement list LD at the end of step S333. The replacement list LD includes, for example, a group ID as information indicating the device group G, first devices, and replacement consumables for each first device. In the example of FIG. 5, “ID-G1” is registered in the replacement list LD as the group ID. The devices “device a” and “device b” registered in the replacement list LD on the left side in FIG. 5 are respective devices 10 belonging to the device group G of the group ID “ID-G1”, namely, respective first devices determined to be included in step S331. While FIG. 5 illustrates “device a” and “device b” for better understanding, serial numbers of the devices 10 are registered in the replacement list LD in the actual implementation. Further, replacement consumables “K ink” and “C, K ink” (cyan and black ink, respectively) in the replacement list LD on the left side in FIG. 5 respectively indicate replacement consumables for “device a” and “device b”, which are both first devices.

In step S335, the management server 40 determines, in accordance with comparison of consumables information with a predetermined first threshold, whether or not the device 10 (second device) which needs replacement of consumables is included in the plurality of devices 10 that are the sources of the device information but do not correspond to a first device. Step S335 corresponds to the second determination step. Further, the management server 40 that performs step S335 functions as the second determination unit 44.

As described above, the process of step S33 (FIG. 3) is performed targeting a single device group G. Therefore, the second device is the device 10 belonging to the same device group G as the first device determined to be included in step S331. By referencing the group management information DB, the management server 40 can identify, as a second device candidate, the device 10 which is included in the same device group G as the first device determined to be included in step S331 but is not the first device and whether or not this device is a second device candidate.

The management server 40 compares the consumables information with the second threshold by referencing device information on each second device candidate stored in step S32. As with the first threshold, the second threshold is preset for each type of consumables information (remaining consumables level). In the determination in step S335, consumables whose remaining consumables level is below the second threshold are replaceable consumables. For example, when the remaining capacity of a waste tank of the device 10 that is one of the second device candidates (device c) is below the second threshold to be compared with the remaining capacity of the waste tank, the management server 40 determines that the device c is one of the second devices.

As a result of referencing the stored device information, if no device 10 whose remaining consumables level is below the second threshold is included in the second device candidates, the management server 40 determines that there is no device 10 (second device) that needs replacement of consumables (step S335, NO), and step S33 ends. On the other hand, if one or more devices 10 whose remaining consumables level is below the second threshold are included in the second device candidates, the management server 40 determines that the second device is included (step S335, YES), and the process proceeds to step S336.

The consumption degree of consumables indicated by the second threshold is lower than the consumption degree indicated by the first threshold. For example, regarding ink level, the first threshold is less than the second threshold. Therefore, the second device has a lower consumption degree than the first device and thus the urgency for replacement of consumables is not as high as that for the first device. Thus, the second device may be referred to as a device for which replacement of consumables is recommended.

In step S336, the management server 40 adds replacement consumables for the second device to the replacement list LD, and step S33 ends. That is, the management server 40 registers replacement consumables of the second device determined to be included in step S335 in the replacement list LD. For replacement consumables of the second device, however, consumables which have been arranged for replacement are not registered in the replacement list LD.

The replacement list LD on the right side in FIG. 5 is the replacement list LD at the end of step S336. That is, the replacement list LD is updated through step S336 after step S333. The device “device c” registered in the replacement list LD on the right side in FIG. 5 is the device 10 belonging to the device group G of the group ID “ID-G1”, namely, the second device determined to be included in step S335. Further, replacement consumable “waste ink tank” in the replacement list LD on the right side in FIG. 5 indicates a replacement consumable (a consumable for which replacement is recommended) for “device c”, which is a second device.

Turning back to FIG. 2, the management server 40 branches the process in accordance with whether or not replacement of consumables is needed (step S34). That is, if step S33 (FIG. 3) has ended via step S334, this corresponds to a case where replacement of consumables is needed, and thus the process proceeds to step S35. On the other hand, if step S33 (FIG. 3) has ended without proceeding via step S334, this corresponds to a case where no replacement of consumables is needed, and thus the management server 40 terminates the flowchart of FIG. 2 without performing step S35.

In step S35, the management server 40 externally transmits an instruction (a delivery instruction) to deliver a replenishment item for a replaceable consumable (an unused consumable). In the example of FIG. 2, the management server 40 transmits a delivery instruction to the terminal 50. The terminal 50 receives the delivery instruction from the management server 40 (step S51). The replacement list LD is included in a delivery instruction. The delivery instruction from the management server 40 may be implemented by transmission of an e-mail, for example.

If step S33 (FIG. 3) has ended with determination of “NO” in step S335, the replacement list LD (the replacement list LD on the left side in FIG. 5) at the end of step S333 is transmitted together with a delivery instruction in step S35. Thereby, the terminal 50 is instructed of delivery of replenishment items of consumables needed by the first devices (for example, the devices a and b) for replacement. On the other hand, if step S33 (FIG. 3) has ended via step S336, the replacement list LD (the replacement list LD on the right side in FIG. 5) at the end of step S336 is transmitted together with a delivery instruction in step S35. Thereby, the terminal 50 is instructed of delivery of replenishment items of consumables needed by the first devices (for example, the devices a and b) for replacement and a replenishment item for consumables needed by the second device (for example, the device c) for replacement.

Step S35 corresponds to a delivery instruction step. Further, the management server 40 that performs step S35 functions as the delivery instruction unit 45. Note that the management server 40 adds, to the record of arranged replacement, the consumables serial number of replacement consumables registered in the replacement list LD transmitted together with a delivery instruction.

After the terminal 50 receives a delivery instruction from the management server 40, substantial arrangement of delivery in accordance with the delivery instruction is performed by the terminal 50 or a manager or the like who operates the terminal 50. A specific scheme of arrangement of delivery is not particularly limited in the present embodiment as long as the replenishment item for a replacement consumable is needed for a specific device 10 of which device group G is identified in accordance with the replacement list LD and as long as the identified replenishment item is delivered to a destination where the replenishment item is needed. Information necessary for delivery of a replenishment item, such as an address, a contact address, or the like of a delivery destination (site premises where the device group G is installed), is stored in the terminal 50 or the management server 40 in advance.

Note that a group ID may be included in device information to be transmitted to the management server 40 from the devices 10 via the monitoring apparatus 20. With a group ID being included in device information, the management server 40 can determine in step S33 whether or not the devices 10 belong to the same device group G by comparing device information of respective devices 10 without referencing the group management information DB.

### 3. Other Embodiments

The present embodiment is not limited to the above details and, for example, includes various forms illustrated below. Even when the devices 10 belong to the same device group G, the actual installation places may be different. For example, it is assumed that, in a corporation, out of a plurality of devices 10 belonging to a single device group G under contact with the management server 40, some of the devices 10 are installed in a first premise and the rest of the devices 10 are installed in a second premise. In such a situation, when the first device described above is located in the first premise and the second device described above is located in the second premise, a replenishment item for the first device and a replenishment item for the second device need to be delivered to different places.

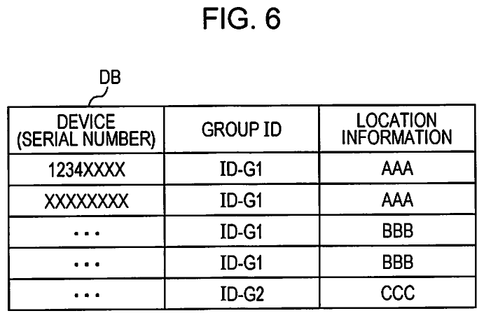

Accordingly, in step S33 (FIG. 3), the management server 40, that is, the second determination unit 44 may determine whether or not the second device is included in the devices 10 which are installed in the same place as the first device but do not correspond to a first device. Specifically, in step S335, by referencing the group management information DB illustrated in FIG. 6, the management server 40 identifies, as the second device candidate, the device 10 which has the same device group G (group ID) as the first device determined to be included in step S331 and is installed in the same place as the first device but is not the first device.

The group management information DB illustrated in FIG. 6 additionally includes location information for each device 10 compared to the group management information DB illustrated in FIG. 4. That is, the management server 40 pre-stores the group management information DB including location information. The location information is information directly or indirectly indicating the installation place of the device 10. The information directly or indirectly indicating the installation place of the device 10 may be, for example, an address, a name of premise, a name of town, identification information uniquely indicating an address, a name of premise, a name of town, or the like. According to the example of FIG. 6, the devices 10 having the same group ID “ID-G1” are divided into the devices whose location information is “AAA” and the devices whose location information is “BBB”. Therefore, if the group ID of the first device determined to be included in step S331 is “ID-G1” and the location information is “AAA”, the presence of the second device is determined in step S335 out of the devices 10 whose group ID is “ID-G1” and location information is “AAA” except the first device.

According to such a configuration, if step S33 (FIG. 3) has ended via step S336, the management server 40 can provide an instruction to collectively deliver respective replenishment items of replacement consumables of the first device and the second device installed in the same place in step S35. As a result, the efficiency of replacement of consumables, that is, the efficiency of delivery of replenishment items for the plurality of devices 10 is further improved. Note that location information used for determining the installation places of the devices 10 may be included in device information transmitted from respective devices 10, for example, other than be stored in the group management information DB.

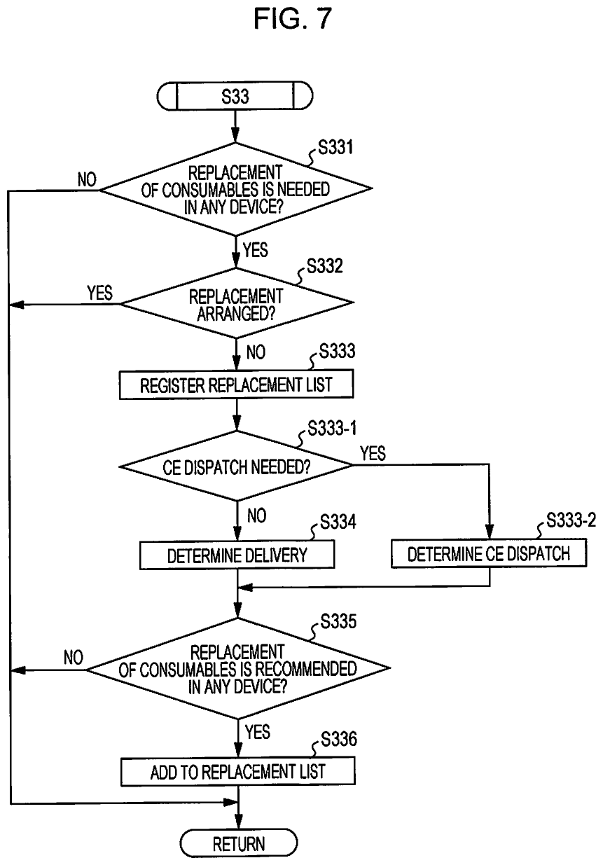

FIG. 7 is a flowchart illustrating details of step S33, which illustrates an example different from FIG. 3. FIG. 7 is different from FIG. 3 in that steps S333-1 and S333-2 are included. After step S333, the management server 40 determines whether or not dispatch of a customer engineer (CE) is necessary for replacement of consumables of the first device (step S333-1). A CE is a staff member having expertise regarding maintenance of the device 10. Dispatch of a CE means that a CE brings a replenishment item of replacement consumables to a customer (a user of the first device). Dispatch of a CE also corresponds to delivery of a replenishment item. However, delivery of a replenishment item described so far is mere delivery (first type of delivery), that is, a replenishment item is simply delivered to a customer by the delivery, and on the other hand, a service by a CE is together provided by dispatch of a CE (second type of delivery). When a CE is dispatched, a replacement operation of a replenishment item for the device 10 is performed by the CE.

If the management server 40 determines that dispatch of a CE is necessary (step S333-1, YES), the process proceeds to step S335 via step S333-2. On the other hand, if the management server 40 determines that dispatch of a CE is unnecessary (step S333-1, NO), the process proceeds to step S335 via step S334. In step S334, the management server 40 determines to deliver a replenishment item of replacement consumables, that is, perform the first type of delivery, as described above. On the other hand, in step S333-2, the management server 40 determines to dispatch a CE, that is, perform the second type of delivery. The management server 40 determines whether or not dispatch of a CE is necessary in accordance with a predetermined criterion. For example, when the consumption degree of replacement consumables of the first device registered in the replacement list LD in step S333 is high enough to require emergent replacement (when the remaining consumable level is less than a predetermined third threshold that is less than the first threshold), the management server 40 determines that dispatch of a CE is necessary. Further, when error information included in device information of the first device registered in the replacement list LD in step S333 indicates occurrence of a predetermined error which needs to be solved by a CE, the management server 40 may determine that dispatch of a CE is necessary.

In step S35, the management server 40 provides a delivery instruction in accordance with either step S334 or S333-2. That is, if step S33 (FIG. 7) has ended via step S334, the management server 40 transmits a delivery instruction to perform the first type of delivery of a replenishment item of replacement consumables together with the replacement list LD in step S35. On the other hand, if step S33 (FIG. 7) has ended via step S333-2, the management server 40 transmits a delivery instruction to perform the second type of delivery of a replenishment item of replacement consumables, that is, delivery by dispatch of a CE together with the replacement list LD in step S35. Thereby, a replenishment item of consumables needed by the first device for replacement and further a replenishment item of consumables needed by the second device for replacement are delivered by the first type of delivery or by the second type of delivery collectively to the user of the device group G to which the first device and the second device belong.

### 4. Conclusion

According to the present embodiment as described above, the management server 40 that manages the plurality of devices 10 includes the receiving unit 42 that receives consumables information on a status of consumables provided in the devices 10, the first determination unit 43 that determines whether or not the first device that needs replacement of the consumables is included in the plurality of devices 10 in accordance with a comparison of the consumables information with the first threshold, the second determination unit 44 that, when the first device is included in the plurality of devices 10, determines whether or not the second device that needs replacement of the consumables is included in the plurality of devices 10 other than the first device in accordance with a comparison of the consumables information with the second threshold, and the delivery instruction unit 45 that, when the second device is included in the plurality of devices 10, provides an instruction to delivery of a replenishment item of the consumables needed by the first device for replacement and a replenishment item of the consumables needed by the second device for replacement.

According to the above configuration, replenishment items for the first device and the second device which need replacement of consumables out of the plurality of devices 10 may be collectively delivered. Such aggregation of respective replenishment items to the plurality of devices 10 may reduce the number of times of delivery of replenishment items. Therefore, the efficiency of replacement of consumables, that is, delivery of replenishment items to the plurality of devices 10 is improved. As is appreciated from the above description, the number of the first devices in not limited to one, and the number of the second devices is not limited to one.

According to the present embodiment, the management server 40 stores the group management information DB that defines a correspondence between the devices 10 and the device group G to which the devices 10 belong. Further, the second determination unit 44 identifies the devices 10 (second device candidates) other than the first device which are included in the device group G to which the first device belongs by referencing the group management information DB and determines whether or not the second device is included in the identified second device candidates. According to the above configuration, the management server 40 may easily and reliably target the devices 10 belonging to the same device group G as the first device and determine whether or not the second device that needs replacement of consumables is included. That is, management of the devices 10 for each device group G is facilitated.

The present embodiment is not limited to the form in which the first device or the second device is determined from the devices 10 in the same device group G. The management server 40 may determine the first device or the second device from the plurality of devices 10 belonging to different device groups G and aggregate delivery instructions of a replenishment item of replacement consumables of the first device and a replenishment item of replacement consumables of the second device. For example, the management server 40 may determine the first device or the second device by targeting a first device group G and a second device group G formed of the devices 10 located in an installation place that is close to (within a predetermined distance of) an installation place of the devices 10 belonging to the first device group G.

Further, according to the present embodiment, the consumption degree of consumables indicated by the second threshold is lower than the consumption degree of consumables indicated by the first threshold. According to the above configuration, it is possible to produce more situations where replenishment items for respective devices 10 are collectively delivered and improve the efficiency of delivery of replenishment items.

What is claimed is:

1. A device management server that manages a plurality of devices, the device management server comprising:
a receiving interface that receives consumables information on a status of consumables provided in the devices; and
a processor that
determines, in accordance with a comparison of the consumables information with a first threshold, whether or not a first device that needs replacement of the consumables is included in the devices,
when the first device is included in the devices, determines, in accordance with a comparison of the consumables information with a second threshold, whether or not a second device that needs replacement of the consumables is included in the devices other than the first device, and
when the second device is included in the devices, provides an instruction to deliver a replenishment item for the consumables needed by the first device for replacement and a replenishment item for the consumables needed by the second device for replacement.

2. The device management server according to claim 1, wherein
group management information that defines a correspondence between the devices and a device group to which the devices belong is stored, and
the processor identifies devices other than the first device which are included in a device group to which the first device belongs by referencing the group management information and determines whether or not the second device is included in the identified devices.

3. The device management server according to claim 1, wherein
a consumption degree of the consumables indicated by the second threshold is lower than a consumption degree of the consumables indicated by the first threshold.

4. The device management server according to claim 1, wherein
the processor determines whether or not the second device is included in devices other than the first device which are installed in a place where the first device is installed.

5. A device management method that manages a plurality of devices, the device management method comprising:
receiving consumables information on a status of consumables provided in the devices;
determining, in accordance with a comparison of the consumables information with a first threshold, whether or not a first device that needs replacement of the consumables is included in the devices;
when the first device is included in the devices, determining, in accordance with a comparison of the consumables information with a second threshold, whether or not a second device that needs replacement of the consumables is included in the devices other than the first device; and
when the second device is included in the devices, providing an instruction to deliver a replenishment item for the consumables needed by the first device for replacement and a replenishment item for the consumables needed by the second device for replacement.

6. A device management system that manages a plurality of devices, the device management system comprising:
receiving interfaces that receive consumables information on a status of consumables provided in the devices; and
processors that
determine, in accordance with a comparison of the consumables information with a first threshold, whether or not a first device that needs replacement of the consumables is included in the devices,
when the first device is included in the devices, determine, in accordance with a comparison of the consumables information with a second threshold, whether or not a second device that needs replacement of the consumables is included in the devices other than the first device, and
when the second device is included in the devices, provide an instruction to deliver a replenishment item for the consumables needed by the first device for replacement and a replenishment item for the consumables needed by the second device for replacement.
